(19) United States
(12) Patent Application Publication
(10) Pub. No.: US 2026/0275620 A1
(43) Pub. Date: Sep. 17, 2026

(54) DRYER MODULE FOR ARTICLES OF CLOTHING

(71) Applicant: JESUS OCTAVIO HERNANDEZ, Charlotte, NC (US)

(72) Inventor: JESUS OCTAVIO HERNANDEZ, Charlotte, NC (US)

(21) Appl. No.: 19/163,025

(22) PCT Filed: Mar. 10, 2024
(86) PCT No.: PCT/IB2024/052300

§ 371 Date: Sep. 8, 2025

(30) Foreign Application Priority Data
Mar. 10, 2023 (CO) NC2023/0002938

(51) Int. Cl. D06F 58/10

(52) U.S. Cl. CPC D06F 58/10

(57) ABSTRACT

The invention relates to a dryer module comprising a structure substantially delimiting a control volume forming an air circulation or exchange chamber, which has side faces that are connected to an upper face and a lower face; the structure has a front face and a rear face; the exchange chamber includes laundry hanging elements that allow for the hanging of objects such as clothes; the rear face includes at least one door. The side faces and the front face selectively include air circulation areas, according to the selected operating modes of the dryer module, and the dryer module includes different geometrical proportions between the total height, total width and total depth. The dryer module includes several means of anchoring to a facade wall.

### FIELD OF THE INVENTION

The present invention relates to the technical field of eco-appliances, which comprises domestic appliances that do not consume electrical energy or fuels, that are environmentally friendly, especially in the field of clothes drying that do not consume electrical energy, require no operational maintenance, and can be coupled to the structures of buildings.

### BACKGROUND OF THE INVENTION

In the state of the art, clothes dryers are known such as the one disclosed in publication US 2003/0037460, which shows a clothes dryer that includes a drum rotatably supported in the housing, having a space to dry clothes inside, a suction duct connected to one side of the drum, to which air is supplied to dry the clothes, an extension duct elongated from the suction duct towards the drum, to make the air supplied from the suction duct flow into the drum, and an exhaust duct connected to the other side of the drum, to expel the air that dried the clothes to the exterior of the housing. The dryer can dry the clothes placed in the drum uniformly by enabling the dryer to directly transmit hot air to the central part of the drum, thereby improving the efficiency of clothes drying.

International publication WO2012/168505 discloses a foldable clothesline that, by means of its own aeration system, reduces the drying time of clothes. The clothesline is composed of hollow tubular bars, mounted on a hollow frame. The entire assembly is supported by two articulated tubular supports. The aeration system is composed of an air blower and a heater for it. By means of this system, hot or non-hot air is introduced under pressure into the interior of the clothesline frame, finally exiting to the exterior through holes made in the lower part of the tubes where the clothes are hung. As the air exits through the holes of the tubes where the clothes are hung, it impinges on them, greatly accelerating the drying process. By means of regulators suitable for this purpose, it allows more or less air flow to exit through the holes of the drying tubes, as well as making it more or less hot.

Patent U.S. Pat. No. 6,363,627 discloses a clothes dryer that includes a casing and a hollow tube connected to a first end of the casing. The casing has a plurality of longitudinally narrow air inlets formed in a bottom, a wind blade wheel rotated by a motor and a heater inside, and a wind outlet formed at the first end connected to an extensible and contractible hollow tube. The hollow tube has a longitudinal L-shaped rail for hanging multiple J-shaped hooks for hooking washed wet clothes and two longitudinal lines of air exhaust holes on two sides of the rail. Therefore, the external cold air flows through the air inlet holes in the casing and is heated by the heater and then blown by the wind blade wheel into the hollow tubes and then exits through the wind exhaust holes to dry the clothes hung on the hooks under the hollow tube.

Considering the aforementioned state of the art, there is a need to provide a device for drying mainly articles of clothing; that does not use electrical energy, that is environmentally friendly; that does not use fans, i.e., is not of the forced type, that does not use resistors or forms of heating that consume any type of electrical or fuel-based energy to perform the drying operation; that takes advantage of external air currents from the environment and the natural convective flow heated within an internal drying chamber by available solar energy, where the drying chamber is traversed by circulating air currents in the clothesline or drying area, and that is also integrable, embedded, or partially contained in the facade of the housing unit or building, in which it is desirable that it complies with urban planning regulations; that is acceptably compatible with the facade, likewise so that it functions as a drying area preferably with a specific destination; that the proposed device be maintenance-free; that it does not use the traditional concepts of a drying appliance, but is more oriented towards the concept of an eco-appliance as a domestic apparatus that uses renewable energies such as solar energy; that it does not use electrical energy, nor fuels and is especially ecological or environmentally friendly, furthermore; that it allows for a fixed drying site to be designated within the housing unit, for example, to avoid hanging clothes in sight on balconies or windows; that it can be implemented in housing units or hotels where there is not enough space for drying clothes, or where there is no defined clothes drying area, or in small-area apartments or in housing units where it is necessary to increase the efficiency of clothes drying, furthermore; that it generates a positive effect on the reduction of energy consumption in the drying operation, in addition to increasing the speed of drying in small-space housing units.

### BRIEF DESCRIPTION OF THE FIGURES

In order to provide a better understanding of the technical characteristics of the invention, aspects will be described by way of example and with reference to the accompanying figures.

FIG. 1A. Cross-sectional view of an example of a dryer module.

FIG. 1B. General isometric view of an example of a dryer module coupled to a facade wall.

FIG. 2A. Cross-sectional view of an example of a dryer module coupled to a facade wall.

FIG. 2B. General isometric view of an example of a dryer module.

FIG. 3. Cross-sectional view of a generalized dryer module with definition of air exchange areas.

FIG. 4. Cross-sectional view of a generalized dryer module with definition of air exchange areas.

FIG. 5. Cross-sectional view of a generalized dryer module with definition of air circulation areas, anchored to a facade and with a receptacle inside the air exchange chamber.

FIG. 6. Cross-sectional view of a schematic example of a dryer module with air exchange areas with grilles on the side faces.

FIG. 7. Cross-sectional view of a schematic example of a dryer module with a double sliding door and openings on the front face.

FIG. 8. Cross-sectional view of a schematic example of a dryer module with a hinged door and a grille portion and opening on the front face.

FIG. 9. Cross-sectional view of a schematic example of a dryer module with a sliding door with grille portions on the front face.

FIG. 10. Cross-sectional view of a schematic example of a dryer module with a hinged door and a complete grille on the front face.

FIG. 11. Cross-sectional view of a schematic example of a dryer module with a sliding door and a complete grille on the front face.

FIG. 12. Cross-sectional view of a schematic example of a dryer module with a hinged door, grille portions on the front face, and at least one reinforcement joined between the base of the dryer module and the facade.

FIG. 13. Cross-sectional view of a schematic example of a dryer module with a double sliding door and a complete grille on the front face.

FIG. 14. Cross-sectional view of a schematic example of a dryer module with hinged doors, a complete grille on the front face, and a mesh in the exchange chamber.

FIG. 15. General isometric view of an example of a dryer module with a sliding door and grilles on various faces.

FIG. 16. General isometric view of an example of a dryer module with a double hinged door with grille portions on various faces.

FIG. 17. General isometric view of an example of a dryer module with a hinged door and a grille with slats in the Z direction.

FIG. 18. General isometric view of an example of a dryer module with a hinged door, grille portions on the side faces and on the front face with openings.

FIG. 19. General isometric view of an example of a dryer module with grille portions on the side faces and at least one reinforcement joined between the base and the facade.

FIG. 20. General isometric view of an example of a dryer module, showing the internal part from the rear.

FIG. 21. General isometric view of an example of a dryer module, showing the internal part from the rear.

FIG. 22. General isometric view of possible examples of dryer modules in various locations on a facade of a building.

FIG. 23. Schematic view of an example of the framework.

FIG. 24. Front view of an example of the dryer module with a flange anchored to a facade wall.

FIG. 25. Isometric view of an example of the dryer module with a flange anchored to a facade wall, with an example of the arrangement of the anchoring elements.

FIG. 26. Isometric view of an example of a dryer module integrated into a facade wall.

### OBJECTS OF THE INVENTION

The object of the present invention discloses a dryer module that comprises a structure that substantially defines a control volume forming an air circulation or exchange chamber, which has side faces that are connected to an upper face and a lower face; the structure has a front face and a rear face; the exchange chamber includes hanging elements that allow for hanging objects such as clothes; the rear face includes at least one door. The side faces and the front face selectively include air circulation areas, according to the selected modes of operation of the dryer module, and the dryer module includes various geometric proportions between the total height, total width, and total depth. The dryer module includes various forms of anchoring to a facade wall.

The dryer module described above, as well as any additional objects that may arise, will be set forth in detail and with the necessary sufficiency in the descriptive chapter disclosed below, which will constitute the basis of the claims chapter.

### DETAILED DESCRIPTION OF THE INVENTION

The present invention proposes a dryer module for articles of clothing, which functions primarily under the principle of natural convection, in which heat transport is carried out by means of air movement.

The dryer module is preferably coupled to a facade of a building, where the term facade generally refers to the exterior faces of a building, dwelling, or housing unit. The preferred buildings are of the residential and hotel type.

A reference system has been specified to provide complete clarity to the disclosed subject matter, which comprises three orthogonal vectors in the X, Y, and Z directions, as well as the associated reference planes P_{XY}, P_{XZ}, P_{YZ}. Furthermore, it is clarified that the plane P_{XY} is substantially parallel to a horizontal plane, to a reference floor, or a plane that is tangent to the surface of the earth.

The dryer module has been defined as a device that allows for the reduction or removal of an excess of water within an article of clothing, where articles of clothing are products made with different kinds of fabrics to cover the body or for warmth. The concept of clothing includes pants, t-shirts, jackets, underwear, gloves, hats, and footwear, among other items.

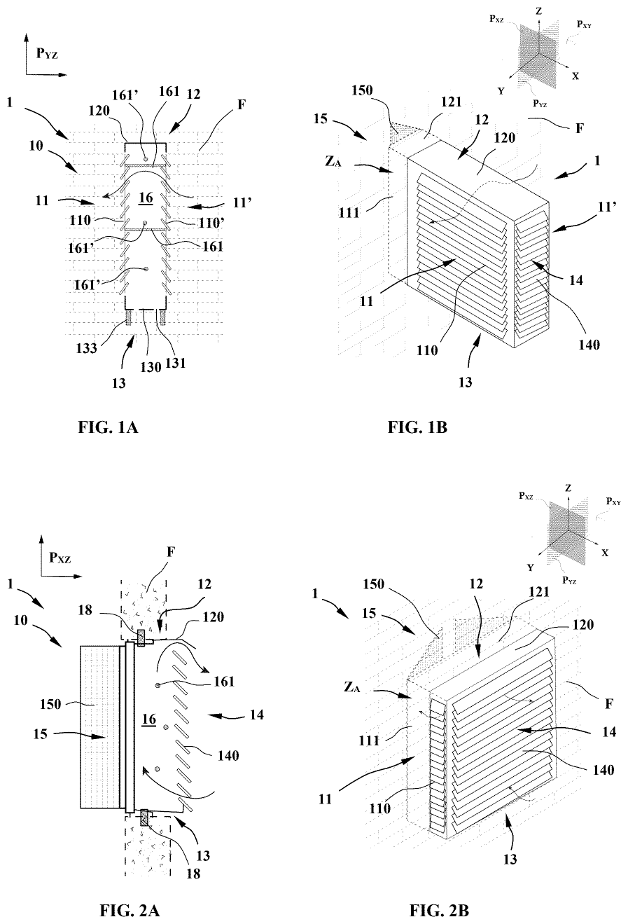

FIGS. 1A and 1B reveal a preferred embodiment of a dryer module (1) for clothes. FIG. 1A shows a section of the dryer module (1) that comprises a structure (10) which includes an upper face (12) having an upper plate (120); the upper face (12) is joined to two side faces (11) (11′); the upper face (12) that has the upper plate (120) is substantially orthogonal to the side faces (11) (11′); the side faces (11) (11′) are joined to a lower face (13) that has a base (130); the upper plate (120), the two side faces (11) (11′), and the base (130) form a hollow surface, which has at the distal end a front face (14) and at the proximal end has a rear face (15) with an opening where a door (150) is coupled.

The upper face (12) with the upper plate (120), the two side faces (11) (11′), the lower face (13) that has the base (130), the front portion (14) and the rear face (15) with the door (150), form a control surface that is the boundary of a control volume that is identified as the air exchange or circulation chamber (16). The exchange chamber (16) is delimited and comprised in a volumetric shape of essentially a parallelepiped or trapezoidal prism; to simplify the examples, reference is made mainly to parallelepiped shapes.

In FIGS. 1A and 1B, it is indicated that the side faces (11) (11′) comprise grilles (110) (110′), but in other embodiments or examples detailed later, they do not include grilles or include them selectively or partially.

The air exchange chamber (16) includes hanging elements (161) and/or (161′), where hangers or the clothes to be dried can be hung directly. The hanging elements (161) are arranged between the two side faces (11) (11′) and their quantity is in the range of 0 to 10, more preferably between 1 to 10. The hanging elements (161′) are arranged, for example, hanging from the upper plate (120) or integral with or fixed to one of the front or side faces. The hanging elements (161) (161′) are selected from metal or synthetic cables or cords; or metal, plastic, or wooden rods or bars. The hanging elements (161) (161′) are located in a direction substantially normal to the side faces (11) (11′) or to the front face (14).

Taking into account the coordinate reference system, the side faces (11) (11′) are contained substantially in planes parallel to the reference plane P_{XZ}, for the present example, but this is not limiting; it may include some type of inclination on any of the faces of the dryer module.

The upper plate (120) and the base (130) are contained substantially in planes parallel to the reference plane P_{XY} and are substantially orthogonal to the side faces (11) (11′). The base (130) prevents articles of clothing from falling or exiting the dryer module (1). The dryer module (1) can also dry other types of objects.

The front face (14) and the rear face (15) are contained in planes substantially parallel to the reference plane P_{YZ}, and are substantially orthogonal to the side faces (11) (11′) and to the upper face (12) and the lower face (13).

The base (130) includes a zone with at least one opening (131) for drainage, which allows the elimination of excess water by means of dripping.

At least one of the side faces (11) (11′) comprises a grille portion (110) (110′).

The upper face (12) has the upper plate (120) which is fixed, not movable, nor in the manner of a door or window.

The front face (14) comprises at least one grille portion (140).

The dryer module (1) for articles of clothing is coupled to a facade (F), in which the dryer module (1) has a coupling zone (ZA) common to the facade (F); the coupling zone (ZA) is a hollow tubular portion that comprises the surfaces indicated as (111) (121), where the coupling zone (Z A) is a transition zone between the door (150) and the air exchange zone; the door (150) opens towards the interior of the housing unit, through which articles of clothing can be hung inside the dryer module (1).

In the present invention, the term facade (F) is equivalent to facade wall, wall, or exterior wall.

Optionally, the base (130) includes at least one reinforcement (133) connected between the base (130) and the facade (F).

The dryer module (1) of FIGS. 1A and 1B has geometric proportions that cause the air flow to occur mainly through the side faces (11) (11′).

Preferably, the movable elements such as the door (150) in a closed state are only contained in planes parallel to the plane P_{YZ}.

The air flows represented by colored lines in the figures are only indicative; these are not necessarily the only directions of air flow.

For the example shown in FIG. 1B, the dryer module (1) is external to the facade, where it is installed through the facade (F). The door (150) is on the interior side of the housing unit or building.

FIGS. 2A and 2B reveal a dryer module (1) for articles of clothing as defined in the descriptions associated with FIGS. 1A and 1B. FIG. 2A shows a section of the dryer module (1) shown in FIG. 2B.

Where the dryer module (1) has geometric proportions that make it flatter and where the air exchange flow mainly occurs through the front face (14).

For the example shown, the door (150) is not comprised in a plane substantially parallel to P_{XY}.

Furthermore, anchoring elements (18) are shown for fixing the dryer module (1) to the facade (F). The anchoring elements (18) are preferably located on the side faces (11) (11′), upper face (12) and/or lower face (13). Included within the anchoring elements (18) are fastening means, fixed anchors, cables, expansion bolts, or equivalents, which help to support the loads to which the dryer modules are exposed.

The upper face (12) can include materials such as glass to allow sunlight to partially pass through the clothesline area, where the upper plate (120) is fixed, not movable, nor in the manner of a door or window.

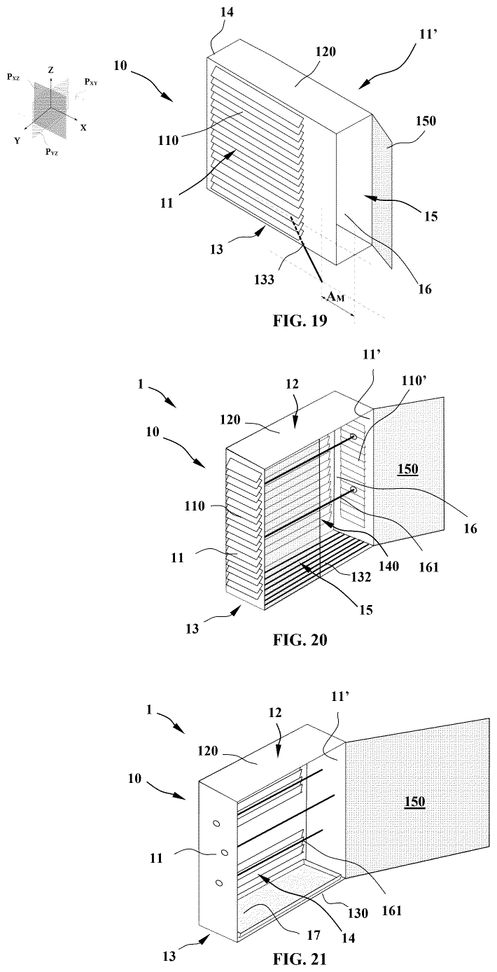

The front face (14) comprises at least one grille portion (140); the grille portions (140) can have other configurations as shown in FIG. 17, and can also include vertical, inclined, or other complex shaped slits, to improve particular drying conditions.

Preferably, the dryer module (1) should be coupled to a facade or to a window structure of a building; the dryer module (1) is less suggested to be coupled to internal walls because it will not have circulation of external air currents nor could it have efficient access to solar energy. In another embodiment, it can be coupled to inclined roofs.

FIG. 3 reveals a generalized example of a schematic arrangement of a dryer module (1), which comprises an exchange chamber (16) that is formed by an upper face (12) that includes an upper plate (120) that connects to the side faces (11) (11′) not shown in FIG. 3, but which are as shown in FIGS. (1B) and/or (2B), in turn these latter side faces (11) (11′) are joined to the lower face (13) which includes a base (130), a front face (14) which has a frontal area (A_{F}) for air exchange, and a rear face (15) which includes a door (150). Furthermore, it shows how at least one hanger (G) can be placed to hang clothes on the hanging elements (161) fixed to the side faces (11) (11′).

The frontal area (A_{F}) for air exchange or circulation may include elements such as grille portions or openings.

The reference distances of the total height (H_{T}) of the dryer module (1) and the total depth distance (P_{T}) are indicated.

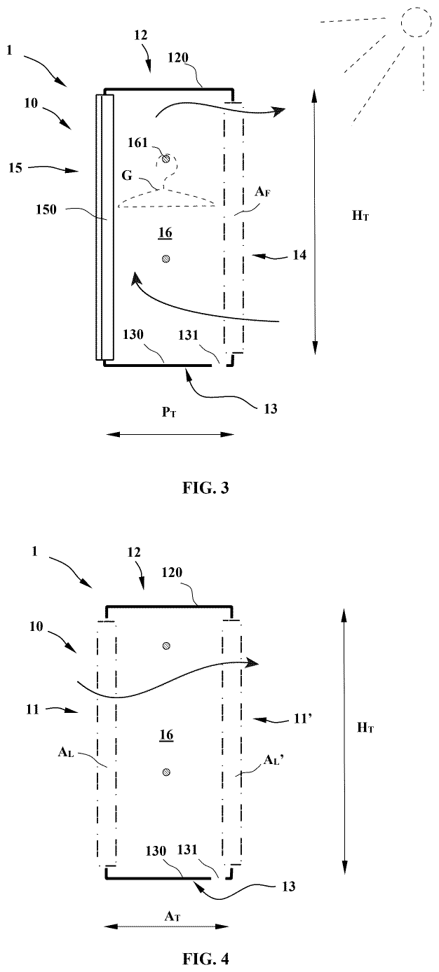

FIG. 4 reveals a generalized example of a schematic arrangement of a dryer module (1) that comprises two side faces (11) (11′) through which an air flow circulates mostly; the side faces (11) (11′) define lateral areas (A_{L}) (A_{L}′) of air exchange, respectively. The lateral areas (A_{L}) (A_{L}′) for air circulation may include elements such as grille portions or openings.

Reference distances such as the total height (H_{T}) of the dryer module and the total width distance (A_{T}) are indicated.

FIG. 5 reveals a sectional view in the P_{XZ} plane of an embodiment in which the dryer module (1) is coupled to a facade (F) by means of the anchors (18); it also reveals that the base (130) supports at least one receptacle (17) or tray for collecting water that may be released from the garments to be dried. The door (150) for this example is single, which can be selected from hinged or sliding.

The frontal area (A_{F}) for air exchange or circulation comprises an upper area (A1), a second intermediate area (A2), and a third lower area (A3).

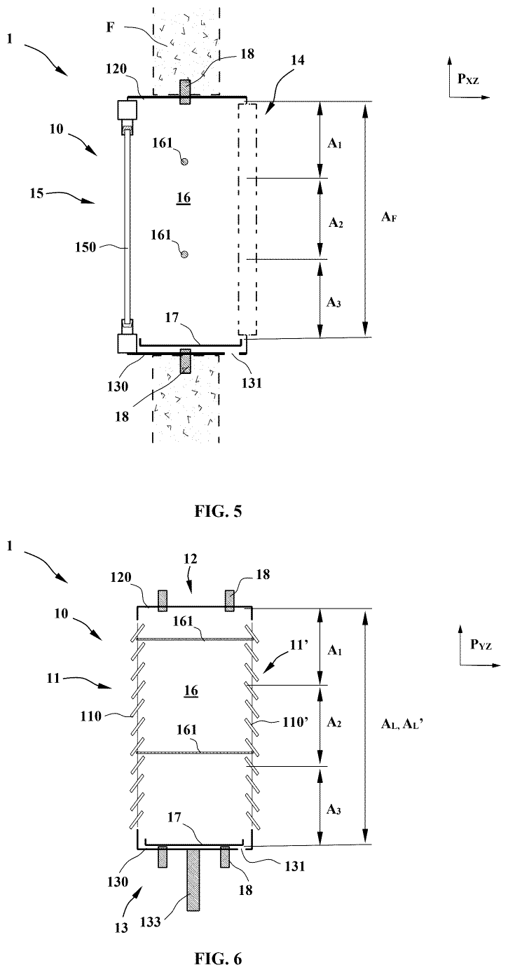

FIG. 6 reveals a sectional view in the P_{YZ} plane of an embodiment in which the dryer module (1) has an exchange chamber (16) and comprises hanging elements (161) that are fixed between the side faces (11) (11′); it is also indicated that the base (130) includes a zone with openings (131) for drainage, some anchors (18) to fix the structure of the dryer module to another structure such as a window frame or a facade, and the location of at least one reinforcement (133) that serves as a bracket to support the dryer module (1) when it is located in a cantilever fashion is also indicated.

In the side faces (11) (11′), they respectively include lateral areas (A_{L}) (A_{L}') of air exchange or circulation, which comprise an upper area (A1), a second intermediate area (A2), and a third lower area (A3).

For the example shown in FIG. 6, the lateral areas (11) (11′) have implemented grilles (110) (110′) in the areas (A1) (A2) (A3) through which the air circulates. In other examples of the invention, the areas (A1) and (A3) have air circulation by means of grilles, openings, or others, and the area (A2) can be without air exchange, and are implemented as a solid layer, plate, or sheet and would have the function of directing the flow in the internal part of the air exchange or circulation chamber (16). In this example of FIG. 6 and in others, the front face (14) can have circulation areas in the form of a grille or openings but can also be without circulation, and the transfer and exchange of air is mostly done through the side faces (11) (11′).

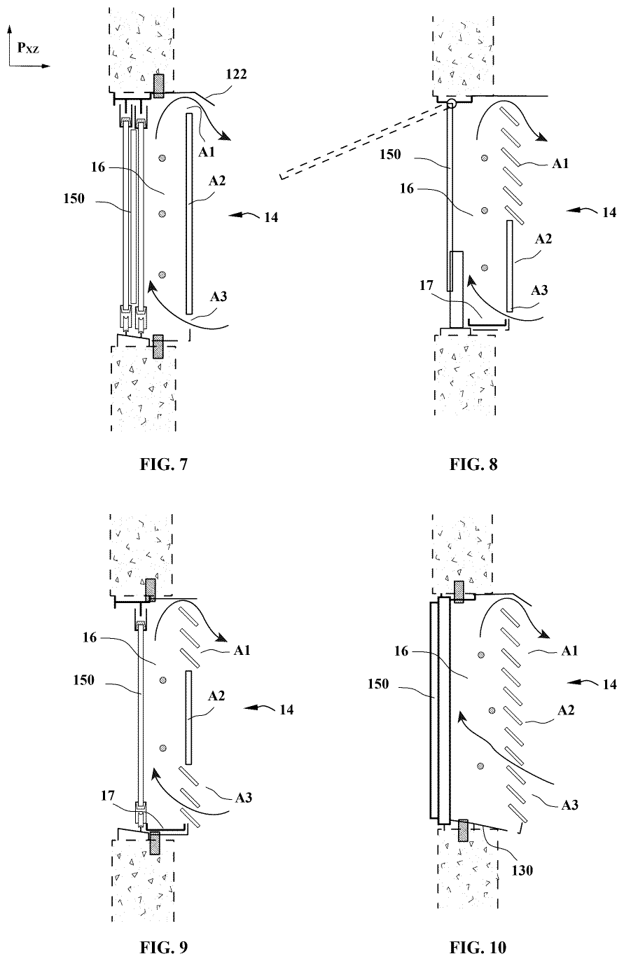

FIG. 7 reveals an example of a dryer module (1) in a sectional view parallel to the P_{XZ} plane at the front face (14), where in the lower area (A3) air enters the dryer module (1) and ascends through the internal part of the air exchange or circulation chamber (16) towards the upper circulation area (A1), through which the moist air or air with a greater amount of water exits. Furthermore, a double sliding type door (150) is shown. The upper plate (120) includes a flange (122) to prevent water from entering the interior of the circulation or exchange chamber (16).

FIG. 8 reveals an example of a dryer module (1) in a sectional view parallel to the P_{XZ} plane, which includes a pivoting door (150) at the upper part that communicates with the air exchange chamber (16) which includes a receptacle (17). The front face (14) that defines a frontal air exchange area (A_{F}) comprises an upper circulation area (A1) that includes a grille portion, a second intermediate area (A2) without air exchange, and a third lower area (A3) with an opening.

FIG. 9 reveals an example of a dryer module (1) in a sectional view parallel to the P_{XZ} plane, which includes a sliding door (150) that communicates with the air exchange chamber (16) which includes a receptacle (17). The front face (14) comprises an upper circulation area (A1) that includes a grille portion, a second intermediate area (A2) without air exchange, and a third lower area (A3) with a grille portion.

FIG. 10 reveals an example of a dryer module (1) in a sectional view parallel to the P_{XZ} plane, which includes a hinged type door (150) that communicates with the exchange chamber (16). The front face (14) comprises an upper air circulation area (A1), a second intermediate area (A2), and a third lower area (A3) forming a complete grille portion. The base (130) optionally has an angle of inclination that allows for the evacuation of water by dripping.

FIG. 11 reveals an example of a dryer module (1) in a sectional view parallel to the P_{XZ} plane that includes a sliding door (150) that communicates with an air circulation or exchange chamber (16). The front face (14) comprises an upper circulation area (A1), a second intermediate area (A2), and a third lower area (A3) forming a grille portion. Furthermore, the upper plate (120) comprises downpipes (123) and a cover (124) like a Chinese hat to prevent water from entering during rain but allowing moist air to be evacuated from the upper part of the dryer module (1). Furthermore, it is revealed that the base (130) is in the form of a grille (132) or parallel bars to improve air circulation in the exchange chamber (16).

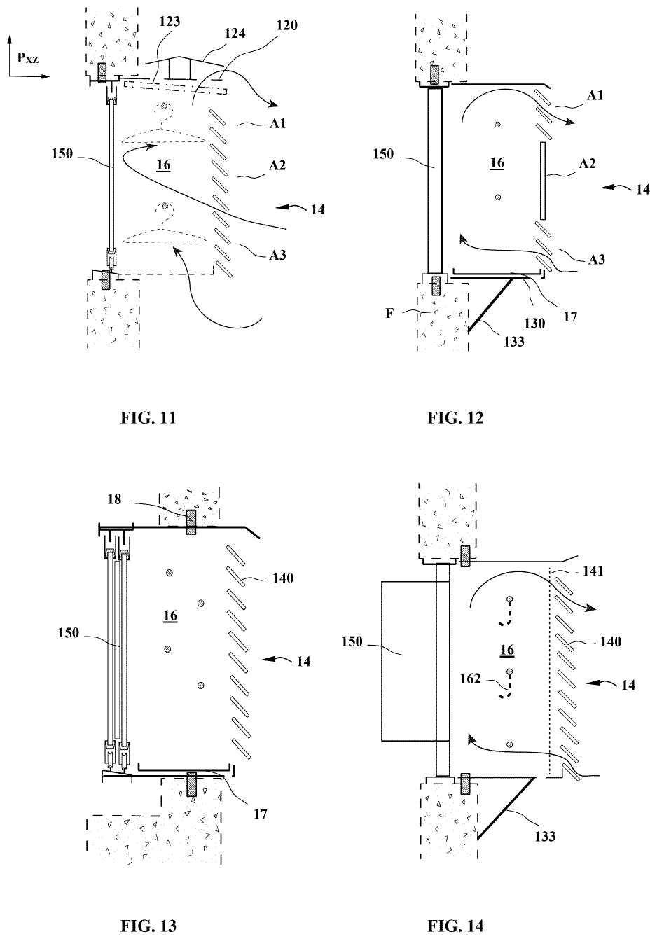

FIG. 12 reveals an example of a dryer module (1) in a sectional view parallel to the P_{XZ} plane, which includes a hinged door (150) that communicates with the air exchange chamber (16) which includes a receptacle (17). The front face (14) comprises an upper area (A1) with air circulation, in the form of a grille portion, a second intermediate area (A2) without air circulation, and a third lower area (A3) in the form of a grille portion. The base (130) is supported by a reinforcement (133) fixed to the facade (F).

FIG. 13 reveals an example of a dryer module (1) in a sectional view parallel to the P_{XZ} plane, which includes a double sliding door (150) that communicates with the exchange chamber (16) which includes a receptacle (17). The front face (14) comprises a frontal area with a grille portion (140).

FIG. 14 reveals an example of a dryer module (1) in a sectional view parallel to the P_{XZ} plane, which includes a double hinged door (150) that communicates with the air exchange chamber (16). The front face (14) comprises a grille portion (140). The base (130) is supported by a reinforcement (133) fixed to the facade (F). Furthermore, the exchange chamber (16) includes hooks (162), and also includes a mesh (141) to restrict the entry of objects or small animals into the dryer module (1).

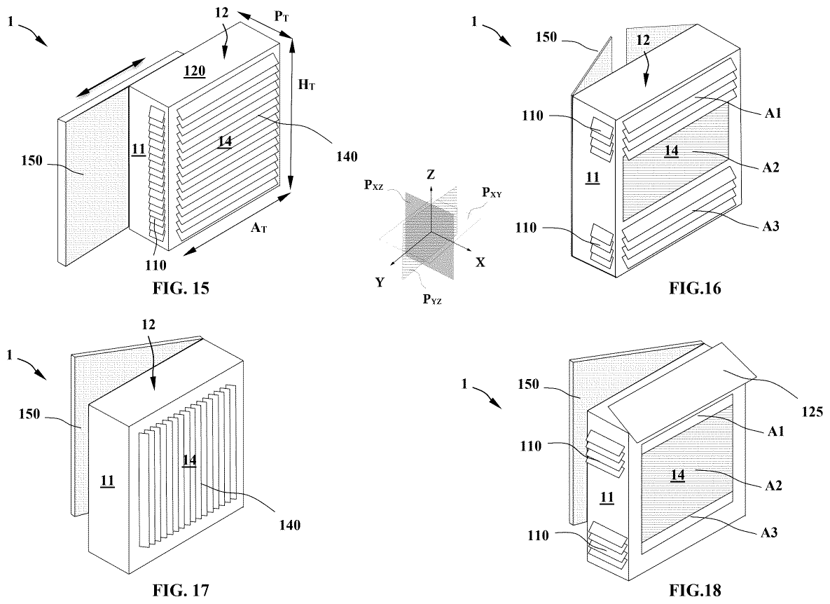

FIG. 15 reveals an example of a dryer module (1) where the external geometry is generally indicated, showing a total height (H_{T}), the total width (A_{T}), and the total depth (P_{T}); a sliding or sliding-type door (150) is shown, at least one of the side faces (11) includes a grille portion (110), the front face (14) includes a grille portion (140).

FIG. 16 reveals an example of a dryer module (1) that includes grille portions (110) on at least one of the side faces (11) and includes grille portions (140) in the upper area (A1) and in the lower area (A3) of the front face (14); in the area A2 there is no grille and it is, for example, a solid plate or glass; this area A2 has no air circulation but rather defines the exchange chamber (16). The example includes a double door (150) that is hinged.

FIG. 17 reveals an example of a dryer module (1) that includes at least a grille portion (140) on the front face (14), where the slats of the grille (140) are arranged in directions substantially parallel to the Z direction; in this example, no grille portions are included on the side faces (11) (11′). The example includes a door (150) that is hinged.

FIG. 18 reveals an example of a dryer module (1) that includes grille portions (110) on at least one of the side faces (11), and includes opening portions in the upper area A1 and lower area A3, on the front face (14); in the intermediate area A2, there is no grille or opening, for example, it is a solid plate or glass in this section A2 which has no air circulation. Furthermore, it includes an inclined plane (125) to prevent the accumulation of snow in winter.

FIGS. 19 to 21 reveal dryer modules (1) viewed from the rear towards the interior of the dryer module.

FIG. 19 reveals a general isometric interior view of an example of a dryer module (1) with a structure (10) with side faces (11) (11′) that include at least one grille portion (110); on the front face (14), which is not shown, it may or may not include at least one grille portion. On the rear face (15), it includes a door (150) that is of the hinged type; on its lower face (13) at the base (130), it comprises at least one reinforcement (133) to improve stability; in some embodiments, the base (130) is sufficiently rigid and is capable of supporting the dryer module (1) when it is coupled directly to a facade or a window frame. It also indicates a facade width distance (A_{M}) that is variable and approximates the width of the facade, wall width, or the width of the window system.

FIG. 20 reveals a general isometric interior view of an example of a dryer module (1), where the side faces (11) (11′) include grille portions (110) (110′) respectively, comprises a double door (150) located on the rear face (15); inside the exchange chamber (16) it includes hanging elements (161) fixed to the side faces (11) (11′), and also shows that the lower face (13) has a grille-shaped base (132) located on it.

FIG. 21 reveals a general isometric interior view of an example of a dryer module (1) where the side faces (11) (11′) do not include grille portions, comprises a hinged door (150) located on the rear face (15), inside the exchange chamber (16) it includes hanging elements (161) located between the side faces (11) (11′), and also shows that the lower face (13) supports a receptacle (17), it is also shown that the front face (14) includes grille portions.

It is clarified that the hanging elements (161) (161′) can be selectively fixed between the side faces (11) (11′), upper face (12), and front face (14), on the inner part of the dryer module. It is also envisaged that there may be some type of hangers or hanging elements supported on the base (130), in any of the previous embodiments.

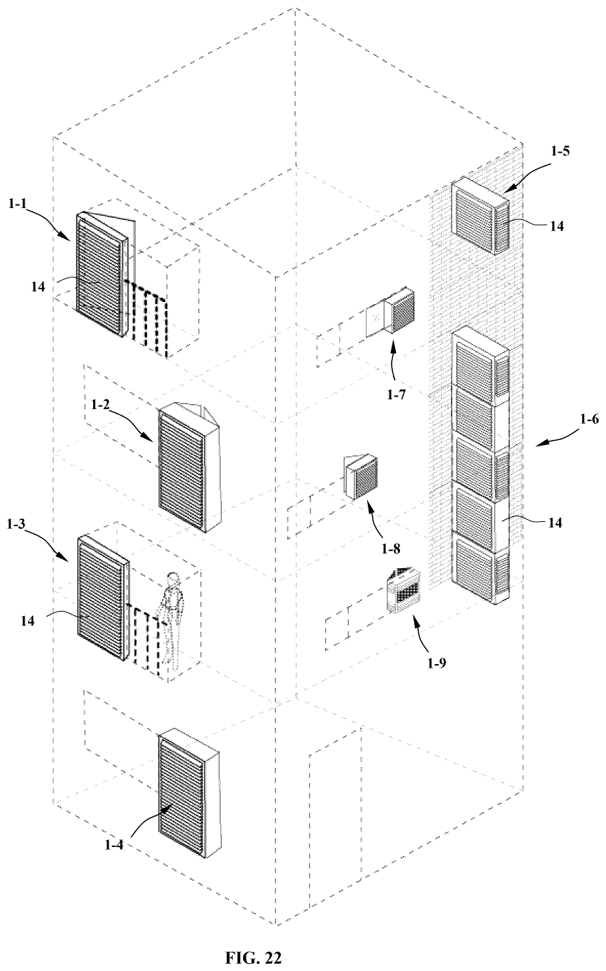

FIG. 22 reveals possible examples of arrangements of dryer modules (1) on the exterior of a building, which are coupled to the facade and/or frames, balconies, external profiles, and/or window systems. Example 1 -1 shows the dryer module arranged on a balcony; 1-2 is integrated into the facade; 1-3 is arranged on a balcony projecting from the facade; 1-4 is integrated into the facade; 1-5 is integrated into the facade; 1-6 are integrated as a column of dryer modules separately or continuously; 1-7 to 1-9 are integrated into the facade through, for example, the window system. The front face (14) is indicated for a general interpretation of the arrangement of the dryer modules; the rear faces that include the doors of the dryer modules are towards the interior of the building.

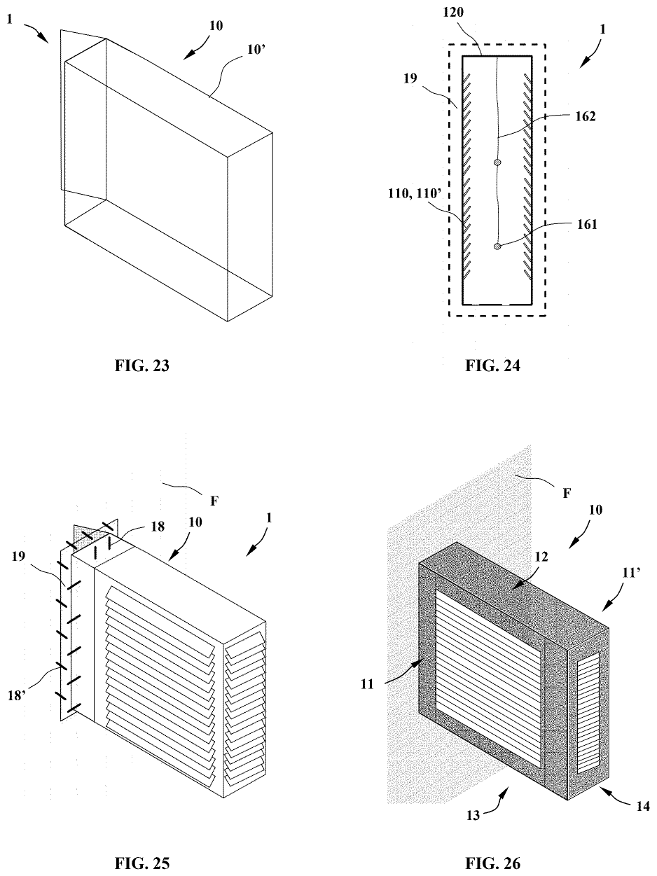

FIG. 23 reveals an embodiment of the structure (10) that includes a framework (10′), which is shown schematically, having structural profiles that give rigidity to the device (1).

In another embodiment, the frame form (10′) may be extended and integrated into the facade or wall (F), with a reinforcement assembly of rebars, beams, stirrups, and/or reinforcements, in the manner implemented in reinforced concrete.

FIG. 24 reveals an embodiment in which it has an anchoring flange (19) that is on the interior side of the dwelling, where the flange (19) is joined to the structure (10) and allows it to be installed from the interior of the dwelling, in the form of a module, to the facade. The anchoring flange (19) allows for improved fastening of the device (1). Furthermore, an embodiment is revealed where the hanging elements (161) are arranged and joined to a hanging element (162) suspended from the upper plate (120). Furthermore, another embodiment is revealed where the grille portions (110) (110′) are towards the interior of the structure (10), allowing for a better way to couple the device to the hole or opening formed in the wall to locate the device. The anchoring flange (19) is located partially or completely around the perimeter of the face (15) towards the interior of the dwelling.

FIG. 25 reveals an embodiment of how the flange (19) is joined to the structure (10). Furthermore, it reveals how the flange (19) is anchored to the facade (F) or wall by means of the anchoring elements (18′), and also shows anchoring elements (18) that allow the other faces of the device to be fixed to the facade (F) or wall. In case of strong winds or for additional security.

FIG. 26 reveals an embodiment where the dryer module (1) with faces (11) (11′) (12) (13) (14) include materials selectively or combined from aluminum, structural steels, wood, thermoplastic polymers, thermosetting polymers, biomaterials, acrylics, concrete, stainless steels. The facade (F) or wall includes materials such as concrete, brick, drywall, wood, expanded polystyrene, mortar, plaster, and similar materials used in the construction of walls. Furthermore, in another embodiment, the structure (10) is cast with the facade (F) or wall. The term cast refers to being integrated in a solid manner, such as a single structure with concrete.

In additional embodiments, it is foreseen that the side faces (11) (11′) and/or the front face (14) are contained substantially in inclined planes not coincident with the reference planes P_{XZ} and/or P_{YZ}.

Where the proportions between the total width (A_{T}) and the total depth (P_{T}) distances are in the ranges of 20:1 to 1:20, more preferably between 15:1 to 1:10, and even more preferably 10:1 to 1:10.

Also preferably defined are the following ranges for the proportions between the total width (A_{T}) and the total depth (P_{T}) distances: 20:1 to 5:1, more preferably between 15:1 to 5:1, and even more preferably between 10:1 to 5:1.

Also preferably defined are the following ranges for the proportions between the total width (A_{T}) and the total depth (P_{T}) distances: 1:20 to 1:5, more preferably between 1:15 to 1:5, and even more preferably between 1:10 to 1:5.

In general, the doors (150) for the previous examples of the invention are selected from the types: sliding, folding, gliding, single and double hinged, which may include only a partial opening, sufficient to comfortably insert and remove garments, and also comprise sealing or adjustment means located on the periphery of the door that are suitable to prevent infiltration into the interior of the building.

In general, in the present invention, the grilles or openings are of the fixed type, but it may include embodiments where the grille is of the movable type in the form of a louver.

The dryer modules (1) do not include sensors, nor actuators, nor motors, nor fans, and do not use electrical energy for their functioning or drying operation.

The dryer module (1) has external dimensions in the operating state, that is, with the door closed, where preferably the sum of its three main edges-height, width, and depth-is between 100 to 500 linear cm, more preferably between 100 to 400 linear cm, and even more preferably between 100 to 300 linear cm.

Although the present invention has been described with the examples shown, it is understood that modifications and variations that preserve the spirit and scope of this invention are understood to be within the scope of the appended claims.

1. A dryer module (1) for articles of clothing, comprising:
a structure (10) with an upper face (12) having an upper plate (120) that is fixed, the upper face (12) is joined to two side faces (11) (11′) which are joined to a lower face (13) having a base (130) with at least one opening (131);
at the distal end, it has a front face (14) and at the proximal end, it has a rear face (15) with an opening where a door (150) is coupled; and
an air exchange chamber (16) having in its interior hanging elements (161) (161′).

2. The dryer module according to claim 1, characterized in that at least one of the side faces (11) (11′) with lateral areas (AL) (AL′) has at least one portion selected from a grille or openings.

3. The dryer module according to claim 1, characterized in that the front face (14) with a frontal area (AF) has at least one grille portion.

4. The dryer module according to claim 1, characterized in that the base (130) supports a receptacle (17).

5. The dryer module according to claim 1, characterized in that it further includes anchoring elements (18) that are selectively fixed on the side faces (11) (11′), upper face (12), and/or lower face (13).

6. The dryer module according to claim 1, characterized in that the doors (150) are selected from the types: sliding, folding, gliding, hinged, and between single and double variants.

7. The dryer module according to claim 1, characterized in that furthermore the proportions of the total width (AT) and total depth (PT) distances are in the ranges of 20:1 to 1:20 and where the sum of the total height (HT), total width (AT), and total depth (PT) is in the range between 100 to 500 linear cm.

8. The dryer module according to claim 1, characterized in that it further includes at least one reinforcement (133) fixed between the base (130) and a facade (F).

9. The dryer module according to claim 1, characterized in that the exchange chamber (16) is selected from the volumetric shapes of a parallelepiped and a trapezoidal prism.

10. The dryer module according to claim 1, characterized in that the hanging elements (161) (161′) are fixed to the faces selected from the side faces (11) (11′), upper face (12), and front face (14).

11. The dryer module according to claim 1, characterized in that the structure (10) includes a framework (10′) with structural profiles.

12. The dryer module according to claim 1, characterized in that the structure (10) includes an anchoring flange (19).

13. The dryer module according to claim 1, characterized in that the faces (11′(11′) (12) (13) (14) include materials selectively or combined from aluminum, structural steels, wood, thermoplastic polymers, thermosetting polymers, biomaterials, acrylics, concrete, and stainless steels.

14. The dryer module according to claim 1, characterized in that the structure (10) is integrally cast with the facade (F).

15. The dryer module according to claim 1, characterized in that it further includes a cover (124).
